(19) United States
(12) Patent Application Publication
(10) Pub. No.: US 2002/0052874 A1
(43) Pub. Date: May 2, 2002

(54) Data vending system and recording medium for use in the system

(76) Inventor: Nami Higashio, Ibaraki-ken (JP)

Correspondence Address: NIXON PEABODY, LLP, 8180 GREENSBORO DRIVE, SUITE 800, MCLEAN, VA, 22102, US

(21) Appl. No.: 09/984,912

(22) Filed: Oct. 31, 2001

(30) Foreign Application Priority Data
Oct. 31, 2000 (JP) 2000-331894
Jul. 31, 2001 (JP) 2001-231212

(51) Int. Cl. G06F 7/00

(52) U.S. Cl. 707/8

(57) ABSTRACT

When a user accesses a data vending system on a telephone or the like, the system allows the user to select one or more pieces of data from a data group consisting of at least one piece of data. The user is charged for the selected piece(s) of data and an identification number representing selected piece(s) of data is issued to the user. The user is issued with a computer-readable recording medium in which the data group is stored, and with a program for executing a procedure of selectively reading out and outputting the piece(s) of data represented by input identification number from the data group stored in the recording medium.

### BACKGROUND OF THE INVENTION

1. Field of the Invention

This invention relates to a data vending system for vending selected pieces of data from a data group consisting of a plurality of pieces of data. This invention further relates to a recording medium for use in the data vending system.

2. Description of the Related Art

There has been known package software consisting of a program for executing various processes and data for use in the processes executed by the program. For example, in a graphic tool, a plurality of pieces of template data representing a circle template, a rectangular template and the like are prepared for enhancing the drawing efficiency in addition to a program for drawing, setting and the like. When a user installs the software, the template data are also installed. The template data incorporated in a graphic tool differ by purpose, price and the like. For example, a graphic tool for mechanical drawing includes template data representing a screw, a pipe, a bolt and the like in addition to a drawing program, whereas a graphic tool for network communication drawing includes template data representing communication devices such as a hub, a router and the like in addition to a similar drawing program.

This is true of, for instance, a postcard making tool. By combining different template data with a program, various kinds of postcard making tools, such as for private use, business use, New Year's greetings and the like, can be obtained.

Though not package software, recording media bearing thereon data such as data on camping sites, lodgings, traffics, golf courses, skiing areas and the like are sometimes offered. For example, golf courses can be grouped by area, such as Kanto area, Chubu area, Kansai area, or overseas.

Such package software and recording media bearing thereon various data have been sold generally in the following two ways. That is, in one way, all the data considered to be in the field (e.g., in the case of the graphic tool, data for mechanical drawing, network communication drawing and the like, in the case of the postcard making tool, data for private use, business use, New Year's greetings and the like) are all packed in one package and the package is sold at a price corresponding to all the data packed in the package. In the case of recording media, data on golf courses in all the areas, e.g., Kanto area, Chubu area, Kansai area, or overseas, are packed in one package and the package is sold at a price corresponding to all the data packed in the package.

In the other way, packages are made purpose by purpose, and the package is sold at a price corresponding only to the data packed in the package. For example, in the case of the postcard making tool, template data for private postcards are packed together with the program in one package and the package is sold as a private postcard making tool package, whereas template data for business postcards are packed together with the same program in one package and the package is sold as a business postcard making tool package. In the case of golf course data recording media, data on the golf courses in the respective areas are separately packed and separately sold at respective prices.

In the former way, the user must purchase desired data together with unnecessary data. For example, an engineer in the network communication field must purchase template data for mechanical drawing together with template data for communication network drawing though he or she needs only the latter, and a student must purchase template data for business postcards together with template data for private postcards though he or she needs only the latter. In the case of data package, for example, a golfer which would not play outside Kanto area must buy the package including therein data on the overseas golf courses which are not necessary for him or her.

In the latter way, there are disadvantages as follows. For example, when both the template data for mechanical drawing and the template data for network communication are necessary for a user, the user must purchase both a mechanical drawing tool package and a network communication drawing tool package. The mechanical drawing tool package and the network communication drawing tool package are the same in the program for carrying out various processes including drawing though different in the template data. Accordingly, to purchase two packages having the same program costs the user as much considering the contents of the two packages. This is true of the postcard making tools.

Further, when the data on the golf courses in the respective areas are separately packed and separately sold at respective prices, the production cost and the distribution cost becomes higher since the number of packages increases, which results in increase in price for one package.

### SUMMARY OF THE INVENTION

In view of the foregoing observations and description, the primary object of the present invention is to provide a data vending system which makes it feasible for the maker to sell software without adding to the production/distribution cost and for the users to conveniently purchase software at a reasonable price.

Another object of the present invention is to provide a computer-readable recording medium employed in accomplishing the primary object.

In accordance with a first aspect of the present invention, there is provided a data vending system comprising an access means which allows access to the system to users, a selection means which allows the user who accesses the system through the access means to select one or more pieces of data from a data group consisting of at least one piece of data, a charging means which charges the user for the selected piece(s) of data, an identification information issuing means which issues to the user with identification information representing selected piece(s) of data, a data issuing means which issues the user with a computer-readable recording medium in which said data group is stored, and a program issuing means which issues the user with a program for executing a procedure of selectively reading out and outputting the piece(s) of data represented by input identification information from the data group stored in the recording medium.

The “access means” means a Web server through a public communication network such as Internet prepared so that a user can purchase desired data, a shop, a telephone, a facsimile, an electronic mail reception window or the like, and by means of the access means, a user can order desired data.

By the “selection means”, the user selects one or more pieces of data from the data group and the selection means may the same as the access means.

The “charging means” is for charging the user for the selected piece(s) of data, and may be, for instance, a means for issuing a bill which is to be paid by a credit card, in advance, by cash at the shop, on delivery, after trial and so forth.

The “identification information issuing means” may be a Web server, a shop, a telephone, a facsimile, an electronic mail reception window or the like as said access means, and by means of the identification information issuing means, a user can obtain identification information.

Access to the system by a user, selection of desired data, charging the user for the selected data and the like may be executed by a Web server, in the shop, by a telephone, by a facsimile, or by an electric mail. However, when the access means, the selection means and the charging means are formed by a Web server, selection of data and charging the user for the selected data can be executed on the display of the user PC by the server in response to access to the Web server by the user. Accordingly, it is preferred that the access means, the selection means and the charging means be formed by a Web server.

It is preferred that the identification information issue means comprises a mail server so that the identification information is issued to the user by electronic mail, thereby providing enhanced security.

The “data issuing means” may issue the recording medium to the user in any way. For example, the data issuing means may issue the recording medium to the user as a postal matter, through a parcel service or by handing in the shop.

The “program issuing means” may issue the program to the user in any way. For example, the program issuing means may issue the program to the user through a file server which allows the user to download the program, as a postal matter, through a parcel service or by handing in the shop.

The program may be issued to the user as recorded in a recording medium. In this case, the recording medium bearing thereon the program may be packed in one package together with the recording medium in which the data group is stored. That is, in this case, the data issuing means and the program issuing means are the same.

The program and the data group may be recorded in the same recording medium.

Though the user gets a recording medium storing therein the whole data group at the first order, the user can use only the data for which the user is charged. It is preferred that when the user makes an order for additional pieces of data, the data becomes available from the recording medium which the user has got. For this purpose, it is preferred that the data vending system of the present invention further comprises a re-access means which allows access to the system to users who already have the recording medium, an additional data selection means which allows the user who accesses the system through the re-access means to select one or more additional pieces of data from the data group, a re-charging means which charges the user for the selected additional piece(s) of data, and an identification information re-issuing means which issues to the user with additional identification information representing selected additional piece(s) of data.

The re-access means, the additional data selection means, the re-charging means and the identification information re-issuing means may be as described above in conjunction with the access means, the data selection means, the charging means and the identification information issuing means.

In order to provide enhanced security and to facilitate customer management, it is preferred that the identification information differs by user.

In accordance with a second aspect of the present invention, there is provided a recording medium for realizing the data vending system in accordance with the first aspect of the present invention. The recording medium is computer-readable recording medium storing therein a data group consisting of at least one piece of data and a program for vending one or more pieces of data from the data group, wherein the improvement comprises that

the program has a procedure of selectively reading out and outputting the piece(s) of data represented by input identification information from the data group stored in the recording medium.

In accordance with the present invention, since the user can use only the selected piece(s) of data the price for which is charged by the charging means even if the user gets a recording medium storing therein all the pieces of data, the distributors have to produce and vend only one kind of product, that is, a recording medium storing therein all the pieces of data. Accordingly, the production cost and the distribution cost can be lowered, whereas the user may pay only for data which he or she orders, which is reasonable.

Further, when the access means, the selection means and the charging means are formed by a Web server, the user can easily get a desired piece of data solely on the Web server through a public network like Internet.

When the identification information is issued to the user through an electric mail, security is enhanced.

Further, when the data vending system of the present invention further comprises the re-access means, the additional data selection means, the re-charging means and the identification information re-issuing means, the data becomes available from the recording medium which the user has got by the user inputting the additional identification information. Accordingly, the distributor can quickly deal with additional orders of the user without sending a recording medium. For the user, the user can save the time for waiting the additional data. Further, the user need not pay double for the same program.

By issuing different identification information by user, security can be enhanced and customer management can be facilitated.

### BRIEF DESCRIPTION OF THE DRAWINGS

FIG. 1 is a block diagram showing a data vending system in accordance with an embodiment of the present invention,

FIG. 2 is a flow chart showing the operation of the data vending system,

FIG. 3 is a schematic view showing an example of the program and the data stored in a CD-ROM which is an example of package software to be vended by the data bending system,

FIG. 4 is a flow chart showing the operation of the install program stored in the CD-ROM shown in FIG. 3, and

FIG. 5 is a flow chart showing the operation of a data vending system in accordance with another embodiment of the present invention.

### DESCRIPTION OF THE PREFERRED EMBODIMENTS

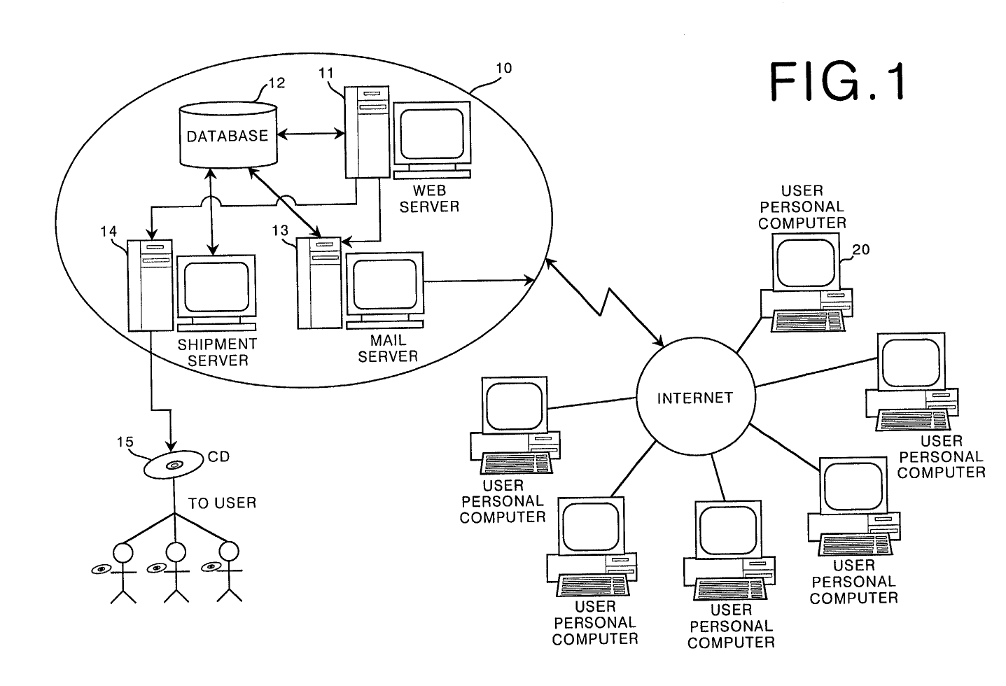

In FIG. 1, a data vending system 10 in accordance with an embodiment of the present invention is a mail-order system for vending package software through Internet and comprises a Web server 11 which receives access from user personal computers 20 and allows users to select one or more pieces of data and to make a paying process for establishing trust in paying the charge for the selected piece(s) of data, e.g., inputting his or her credit card number, a mail server 13 which sends data including identification information to the corresponding user personal computer 20, a database 12 which stores information on the user such as user's address, name, mail address, identification information and the like, and a shipment server 14 which controls shipment of package software (e.g., a CD-ROM) storing therein data group and the program.

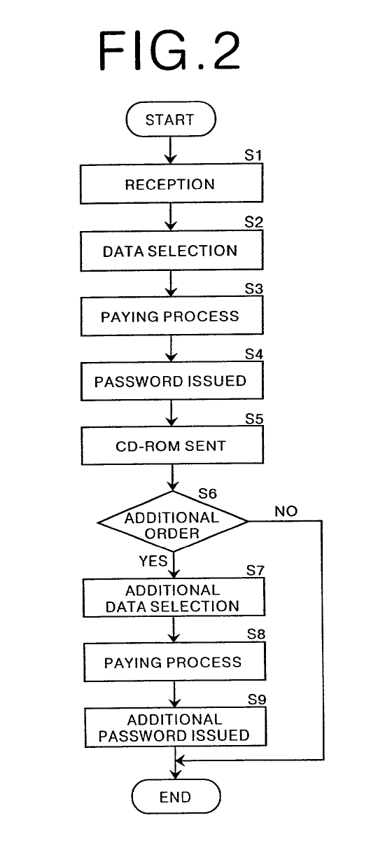

As shown in FIG. 2, when a user accesses to the system, the system receives an order from the user PC 20 in a Web page constructed on the Web server 11 (step S1), and allows the user to select one or more pieces of data from a plurality of pieces of data (step S2). Then the system allows the user to input user information such as user's address, name, mail address and the like, and the system charges the user for the selected piece(s) of data. (step S3) For example, in the case where the charge is to be paid in advance, the system tells the user the number of the account to which the charge is to be transferred and proceeds to step S4 after confirmation of payment. In the case of post payment, the system receives information on the user such as address, telephone number and the like from the user. The bill may be sent to the user together with the CD-ROM to be described later. The paying process in step S3 may be executed by inputting, for instance, the credit card number on a Web page protected by security or by the use of Web money. The input user information is stored in the database 12.

Thereafter, the system causes the mail server to tell the user a password (identification information) corresponding to the selected piece(s) of data by electric mail. (step S4) Then the system causes the shipment server 14 to send a CD-ROM 15 storing therein the data group and the program to the user on the basis of the user information stored in the database 12. The password is issued according to the combination of the user and the data selected by the user as will be described later.

When a user who purchased a CD-ROM before accesses the Web server 11, paying process is carried out in the same manner as in step S3 on the additional data selected by the user and an additional password corresponding to the additional data is sent to the user by electric mail in the same manner as in step S4. (steps S6 to S9)

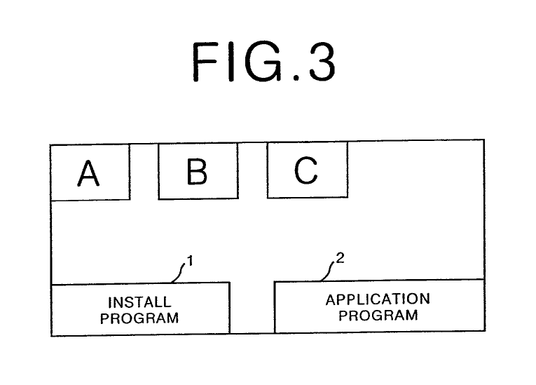

FIG. 3 shows an example of the structure of the program and the data group stored in a CD-ROM of package software, which is a New Year's greeting postcard making tool in this particular example.

As shown in FIG. 3, in the CD-ROM 15 of the package software, template data A of New Year's greeting postcard for business use, template data B of New Year's greeting postcard for casual use, and template data C of New Year's greeting postcard for different Eto's (Japanese zodiac signs) are stored as well as application programs 2 having functions of drawing, character input, printing control and the like for making New Year's greeting postcards, and the program 2 and the data A, B and C are installed by an install program 1.

The password for each user and each piece of data is eight bits in length. The four high-order bits represents the identification number of the user and four low-order bits correspond to pieces of data stored in the CD-ROM 15. For example, when the thousandth user (given an identification number of 1000) orders data A and data B, the password issued to the user will be 10001100. Similarly, when a user given an identification number of 1234 orders data A, data B and data C, the password issued to the user will be 12341110.

The install program 1 installs as well as the application program 2 one or more piece(s) of template data (A, B, C) represented by the password.

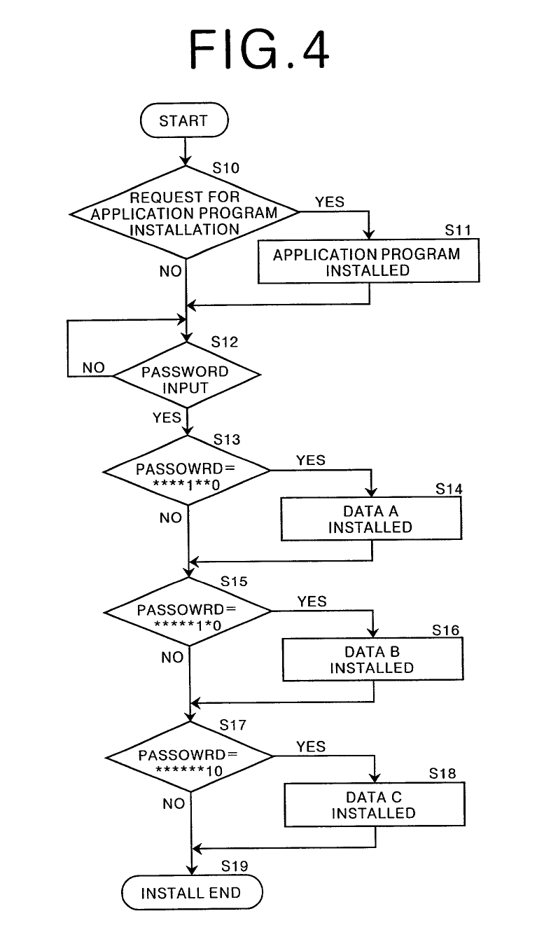

FIG. 4 is a flow chart for illustrating the operation of the install program 1 stored in the CD-ROM 15 shown in FIG. 3.

As shown in FIG. 4, when the install program 1 is requested to install an application program, the install program 1 causes the system to install the application program 2. (steps S10 and S11) Otherwise the install program 1 proceeds to step S12 and waits for a password to be input.

When a password is input, the install program 1 causes the system to determine whether the password corresponds to data A. (steps S12 and S13) When the password is . . . . 1 . . 0, that is, the fifth bit is 1, the install program 1 causes the system to read out and install data A (the template data of New Year's greeting postcard for business use). (step S14) When it is determined that the password does not correspond to data A or after installation of data A, the install program 1 causes the system to determine whether data B is selected. (step S15) When the password is . . . . . 1.0, that is, the sixth bit is 1, the install program 1 causes the system to read out and install data B (New Year's greeting postcard for casual use). (step S16) When it is determined that the password does not correspond to data B or after installation of data B, the install program 1 causes the system to determine whether data C is selected. (step S17)

When the password is . . . . . . 10, that is, the seventh bit is 1, the install program 1 causes the system to read out and install data C (New Year's greeting postcard for different Eto's). (step S18) When it is determined that the password does not correspond to data C or after installation of data C, install is ended. (step S19)

In the mail-order system of New Year's greeting postcard making system of this embodiment, since the user can use only the selected piece(s) of data the price for which is charged to the user even if the user gets a CD-ROM storing therein all the pieces of New Year's greeting postcard template data for the respective purposes (A, B and C) together with the application program 2 for New Year's greeting postcard making, the distributors have to produce and vend only one kind of product, that is, a recording medium storing therein all the pieces of data. Accordingly, the production cost and the distribution cost can be lowered, whereas the user may pay only for data which he or she orders, which is reasonable.

Further, when a user who has got the CD-ROM wants to use other data stored in the CD-ROM, the user can get the additional data from the CD-ROM which he or she keeps by obtaining a password corresponding to the additional data. That is, the distributor need not send another CD-ROM to the user, which is convenient to both the distributor and the user. Especially, in the case of package software, the user need not pay for the same application program for additional data.

Further in this embodiment, since the password differs by user, security can be enhanced and customer management can be facilitated. Though, in the description above, the install program 1 refers to only four low-order bits when verifying the password, it is preferred that the relation between the password, and the data and the user be more complicated.

Though a data vending system in accordance with a preferred embodiment of the present invention has been described above, the present invention need not be limited to the preferred embodiment described above.

For example, though, in the embodiment described above, the password (identification information) is issued to the user through electric mail by the mail server 13, the password may be issued to the user on a Web page.

Further, though, in the embodiment described above, the access means is formed by a Web server 11, the access means may comprise a telephone, handing in the shop, a facsimile, or electric mail. So may the selection means, identification information issuing means, re-access means, additional data selection means, and identification information re-issuing means.

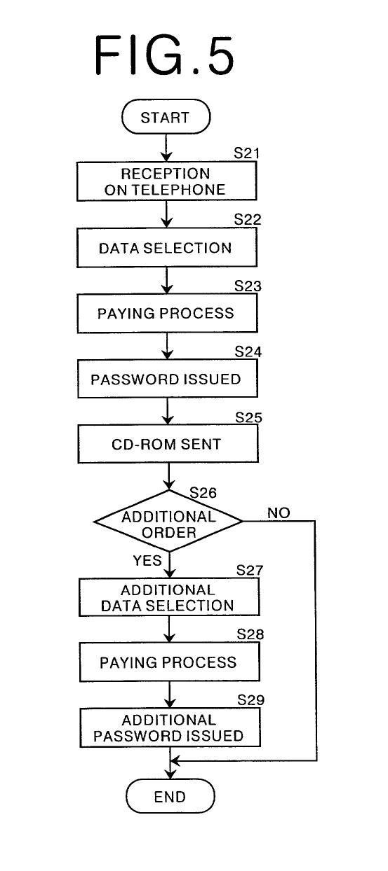

FIG. 5 is a flow chart for illustrating the operation of a data vending system in accordance with another embodiment of the present invention where a telephone is employed as the access means. As shown in FIG. 5, the system receives an order from the user on a telephone (step S21), and allows the user to select one or more pieces of data from a plurality of pieces of data (step S22). Then the system charges the user for the selected piece(s) of data. (step S23) As in the embodiment described above, in the case where the charge is to be paid in advance, the system tells the user the number of the account to which the charge is to be transferred and proceeds to step S24 after confirmation of payment. In the case of post payment, the system receives information on the user such as address, telephone number and the like from the user. The bill may be sent to the user together with the CD-ROM to be described later.

Thereafter, the system tells the user a password corresponding to the selected piece(s) of data on a telephone or a facsimile. (step S24) Then the system sends a CD-ROM 15 storing therein the data group and the program to the user by parcel service. The password is issued according to the combination of the user and the data selected by the user and may be of the same structure described above in conjunction with the data vending system 10 in accordance with the first embodiment.

When the system receives an additional order from a user who purchased a CD-ROM before, paying process is carried out on the additional data selected by the user and an additional password corresponding to the additional data is sent to the user. (steps S26 to S29)

The structure of the package software and the operation of the install program are same as those in the data vending system 10 of the preceding embodiment, and accordingly will not be described here.

Substantially the same result as in the first embodiment can be obtained in this embodiment where a telephone is employed as the access means and the selection means, transfer is employed as the charging means and a telephone or a facsimile is employed as the identification information issuing means.

Though, in the embodiments described above, the CD-ROM is issued to the user by a parcel service, the CD-ROM may be issued to the user by mail, by handing in the shop, or the like. 15 Though, in the embodiments described above, the application program 2 and the install program 1 are separate from each other, the install program 1 may form a part of the application program 2.

Though, in the embodiments described above, the application program 2 and the install program 1 are stored in a CD-ROM together with the data group, they may be stored in a recording medium different from the recording medium in which the data group is stored. Further, the install program 1 may be arranged to be downloaded, for instance, from a file server.

Though, in the embodiments described above, the vending system for vending New Year's greeting postcard making package software is described by way of example, the present invention can be applied to vending of any package software so long as it requires a plurality of pieces of data by purpose, level or the like.

Further, the present invention can be applied also to vending of data only. For example, the present invention can be applied also to vending of a recording medium storing therein total leisure information data such as data on lodgings, restaurants, traffics, golf courses, camping sites and the like, a CD-ROM storing therein patent publication data by field and a CD-ROM storing therein an encyclopedia by field.

Further, a floppy disc, an MO disc, a ZIP disc or the like may be employed in place of a CD-ROM as the recording medium depending on the amount of data to be stored therein.

What is claimed is:

1. A data vending system comprising
an access means which allows access to the system to users,
a selection means which allows the user who accesses the system through the access means to select one or more pieces of data from a data group consisting of at least one piece of data,
a charging means which charges the user for the selected piece(s) of data, an identification information issuing means which issues to the user with identification information representing selected piece(s) of data,
a data issuing means which issues the user with a computer-readable recording medium in which said data group is stored, and
a program issuing means which issues the user with a program for executing a procedure of selectively reading out and outputting the piece(s) of data represented by input identification information from the data group stored in the recording medium.

2. A data vending system as defined in claim 1 in which said program is recorded in the recording medium in which the data group is stored.

3. A data vending system as defined in claim 1 in which the access means, the selection means and the charging means are formed by a Web server.

4. A data vending system as defined in claim 1 in which the identification information issue means comprises a mail server.

5. A data vending system as defined in claim 1 further comprising
a re-access means which allows access to the system to users who already have the recording medium,
an additional data selection means which allows the user who accesses the system through the re-access means to select one or more additional pieces of data from the data group,
a re-charging means which charges the user for the selected additional piece(s) of data, and
an identification information re-issuing means which issues to the user with additional identification information representing selected additional piece(s) of data.

6. A data vending system as defined in claim 1 in which the identification information differs by user.

7. A computer-readable recording medium storing therein a data group consisting of at least one piece of data and a program for vending one or more pieces of data from the data group, wherein the improvement comprises that
the program has a procedure of selectively reading out and outputting the piece(s) of data represented by input identification information from the data group stored in the recording medium.
